(19) United States
(12) Patent Application Publication
(10) Pub. No.: US 2023/0086616 A1
(43) Pub. Date: Mar. 23, 2023

(54) ABSOLUTE POSITION DEVICE, SYSTEM, AND METHOD

(71) Applicant: Optisys, Inc., West Jordan, UT (US)

(72) Inventors: Clinton Cathey, West Jordan, UT (US); Daniel Ricks, West Jordan, UT (US)

(73) Assignee: Optisys, Inc., West Jordan, UT (US)

(21) Appl. No.: 17/932,635

(22) Filed: Sep. 15, 2022

Related U.S. Application Data
(60) Provisional application No. 63/245,660, filed on Sep. 17, 2021.

(51) Int. Cl. G01D 5/14; H01Q 3/04

(52) U.S. Cl. CPC G01D 5/142; H01Q 3/04

(57) ABSTRACT

Systems and methods for determining absolute position. A system includes a first bull gear and a second bull gear rigidly connected to the first bull gear. The system includes a first pinion gear rotationally engaged with the first bull gear. The system includes a second pinion gear rotationally engaged with the second bull gear. The system includes a first sensor that senses a first angular position of the first pinion gear. The system includes a second sensor that senses a second angular position of the second pinion gear.

### CROSS-REFERENCE TO RELATED APPLICATIONS

This Application claims the benefit of U.S. Provisional patent Application No. 63/245,660, filed Sep. 17, 2021, titled “ABSOLUTE POSITION DEVICE, SYSTEM, AND METHOD,” which is incorporated herein by reference in its entirety, including but not limited to those portions that specifically appear hereinafter, the incorporation by reference being made with the following exception: In the event that any portion of the above-referenced provisional application is inconsistent with this application, this application supersedes the above-referenced provisional application.

### TECHNICAL FIELD

This application is directed to means for determining position of an element and are specifically directed to determining absolute rotational position of an element in real-time.

### BACKGROUND

Positional sensors are implemented in numerous industries to determine the absolute or relative position and rotation of different elements. Many electromechanical systems and technologies driven by machinery (e.g., gears, motors, and shafts, etc.) depend on accurate positioning of elements for proper operation. In many cases, it is desirable to determine the angular position of an output shaft, such as on an antenna array, satellite, power-producing panel, optical system, weapons system, and others. The aforementioned systems may configure certain elements that are positioned by gears, motors, shafts, or a combination thereof in conjunction with electrical components and software that are used to tune the antennas to pick up desired signals such as radio waves, television signals, communication signals, or any electromagnetic waves and the like.

Some angular positioning systems are implemented to determine an angular position of an output gear that is attached to another element. The angular position of the output gear may be determined based on relative positions of other gears, as determined by one or more sensors. These traditional systems typically provide rough positional estimates that are not suitable in some finely tuned systems, such as antennas, satellites, and so forth.

In view of the foregoing, described herein are improved systems, methods, and devices for determining an angular position of an element. The systems, methods, and devices described herein can be implemented in finely tuned systems wherein the precise angular position of an element must be determined in real-time.

### BRIEF DESCRIPTION OF THE DRAWINGS

Non-limiting and non-exhaustive implementations of the disclosure are described with reference to the following figures, wherein like reference numerals refer to like parts throughout the various views unless otherwise specified. Advantages of the disclosure will become better understood with regard to the following description and accompanying drawings where:

FIG. 1 illustrates a perspective view of a system for determining an angular position of an element;

FIG. 2 illustrates a straight-on side view of the system for determining an angular position of an element;

FIG. 3 illustrates a top-down view of the system for determining an angular position of an element;

FIG. 4 illustrates an underside view of the system for determining an angular position of an element;

FIG. 5A is a graphical representation of a difference between rotation rates and complete rotations, as well as phase differences between first and second pinion gears of the system for determining an angular position of an element;

FIG. 5B is a graphical representation of a difference between rotation rates and complete rotations, as well as phase differences between first and second pinion gears of the system for determining an angular position of an element;

FIG. 6 is a schematic block diagram of an example computing devices;

FIG. 7 is a schematic flow chart diagram of a method for calculating a position of an output gear; and

FIG. 8 is a schematic flow chart diagram of a method for calculating a position of an output gear.

### DETAILED DESCRIPTION

Disclosed herein are systems, methods, and devices for determining an absolute position of an axis of rotation. The disclosures herein may specifically be applied to systems with fine positional accuracy, including antennas, robotics, optical devices, weaponry devices, and others. The improved position sensing devices described herein may be used in connection with resolvers, encoders, or other position sensing devices.

Specifically disclosed herein are systems for determining an angular position of an output element, such as an output gear or output shaft. The systems described herein may be used in connection with resolvers, encoders, or other position sensing devices, to determine finely tuned angular positions. The systems described herein include two or more bull gears, wherein each of the two or more bull gears are rigidly affixed to one another and/or rigidly affixed to a same output shaft. The systems further include a pinion gear associated with each of the two or more bull gears. Each of the pinion gears is in communication with an angular position sensor that determines the absolute or relative angular position of the respective bull gear. The systems further include a controller in communication with each of the angular position sensors, wherein the controller determines an angular position of the two or more bull gears and/or the output shaft based on the angular positions of the pinion gears.

In the following description, for purposes of explanation and not limitation, specific techniques and embodiments are set forth, such as particular techniques and configurations, in order to provide a thorough understanding of the devices, systems, and methods disclosed herein. While the techniques and embodiments will primarily be described in context with the accompanying drawings, those skilled in the art will further appreciate that the techniques and embodiments may also be practiced in other similar devices.

Reference will now be made in detail to the exemplary embodiments, examples of which are illustrated in the accompanying drawings. Wherever possible, the same reference numbers are used throughout the drawings to refer to the same or like parts. It is further noted that elements disclosed with respect to particular embodiments are not restricted to only those embodiments in which they are described. For example, an element described in reference to one embodiment or figure, may be alternatively included in another embodiment or figure regardless of whether or not those elements are shown or described in another embodiment or figure. In other words, elements in the figures may be interchangeable between various embodiments disclosed herein, whether shown or not.

Before the structure, systems, and methods of angular positioning determination are disclosed and described, it is to be understood that this disclosure is not limited to the particular structures, configurations, process steps, and materials disclosed herein as such structures, configurations, process steps, and materials may vary somewhat. It is also to be understood that the terminology employed herein is used for the purpose of describing particular embodiments only and is not intended to be limiting since the scope of the disclosure will be limited only by the appended claims and equivalents thereof.

In describing and claiming the subject matter of the disclosure, the following terminology will be used in accordance with the definitions set out below.

It must be noted that, as used in this specification and the appended claims, the singular forms “a,” “an,” and “the” include plural referents unless the context clearly dictates otherwise.

As used herein, the terms “comprising,” “including,” “containing,” “characterized by,” and grammatical equivalents thereof are inclusive or open-ended terms that do not exclude additional, unrecited elements or method steps.

As used herein, the phrase “consisting of” and grammatical equivalents thereof exclude any element or step not specified in the claim.

As used herein, the phrase “consisting essentially of” and grammatical equivalents thereof limit the scope of a claim to the specified materials or steps and those that do not materially affect the basic and novel characteristic or characteristics of the claimed disclosure.

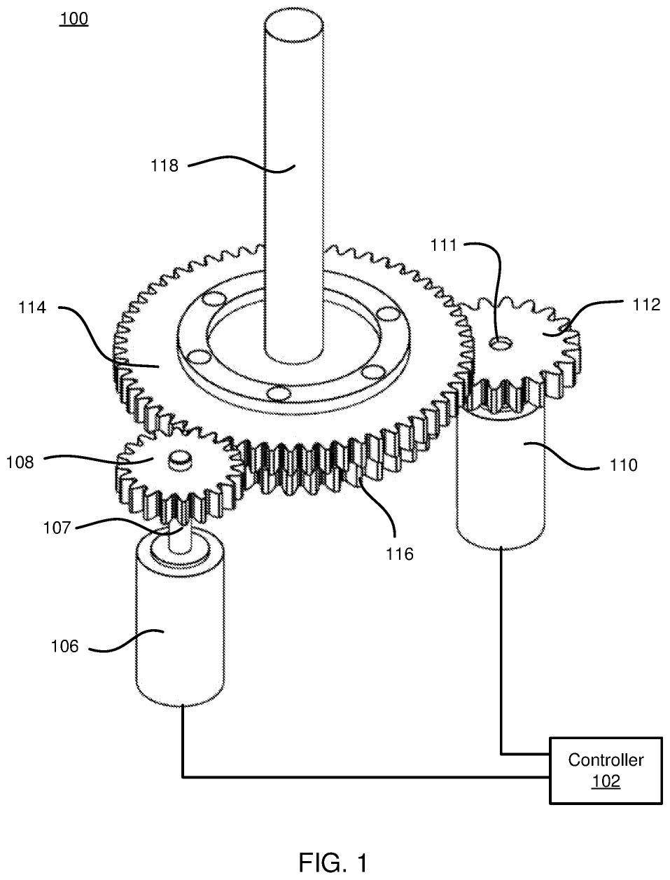

Referring now to the figures, FIG. 1 is an isometric view of an exemplary system 100 for angular positioning. The system 100 includes a controller 102 configured to receive sensor outputs and determine angular positions of various elements of the system 100. The system includes a first angular position sensor 106 and a second angular position sensor 110.

The angular position sensors 106, 110 are configured to sense angular positions and then relay data to the controller 102. The first angular position sensor 106 includes a first shaft 107 and a first pinion gear 108. The second angular position sensor 110 includes a second shaft 111 and a second pinion gear 112. The shafts 107, 111 may be fixed to the pinion gears 108, 112. The angular position sensors 106, 110 are implemented as any sensor or device that provides an angular position of an element, and specifically may include one or more of a resolver, synchro, potentiometer, encoder, Hall effect angular position sensor, rotary variable differential transformer, or similar sensor that provides angular positions.

The first pinion gear 108 rotationally engages with a first bull gear 114 to form a first gear set. The second pinion gear 112 rotationally engages with a second bull gear 116 to form a second gear set. The bull gears 114, 116 together may be considered an output gear fixed to a shaft 118. The pinion gears 108, 112, the bull gears 114, 116, and the angular position sensors 106, 110 each rotationally engage with one another. When the shaft 118 is rotated, the shaft 118 imparts rotation to the bull gears 114, 116, and in turn, the bull gears 114, 116 impart rotation to the pinion gears 108, 112, and in turn, the pinion gears 108, 112 impart rotation to the angular position sensors 106, 110.

The angular position sensors 106, 110 relay data and measurements to the controller 102 indicating the angular positions of the pinion gears 108, 112. The controller 102 interprets the data from the angular position sensors 106, 110 to determine the angular positions of the pinion gears 108, 112. The controller 102 further calculates the angular position of the shaft 118 and the bull gears 114, 116 using the angular positions of the first angular position sensor 106 and the second angular position sensor 110.

Although not pictured, the system 100 may include a component fixed to the shaft 118, such that the controller 102 determines the angular position of this component based on the data received from the angular position sensors 106, 110. The system 100 is universal in application and may be applied to any component or device that is positioned by a gear, shaft, or other machinery that may be attached to the shaft 118. The system 100 may specifically be applied to antennas, satellite dishes, power-producing panels or devices, weaponry, or other devices. The systems and methods described herein are implemented to accurately move, control, and position the device affixed to the shaft 118.

The pinion gears 108, 112 and bull gears 114, 116 may include any suitable gear. FIG. 1 illustrates a use-case that implements spur gears, but the pinion gears 108, 112 and bull gears 114, 116 may include other types of gears, including anti-backlash gears, worm gears, bevel gears, and others.

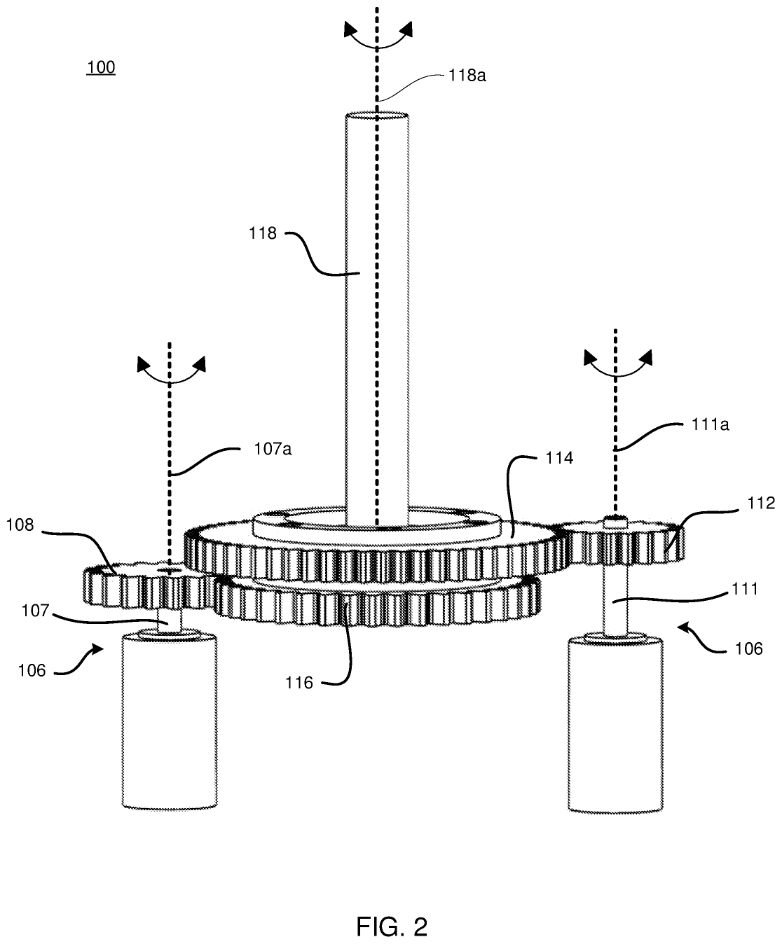

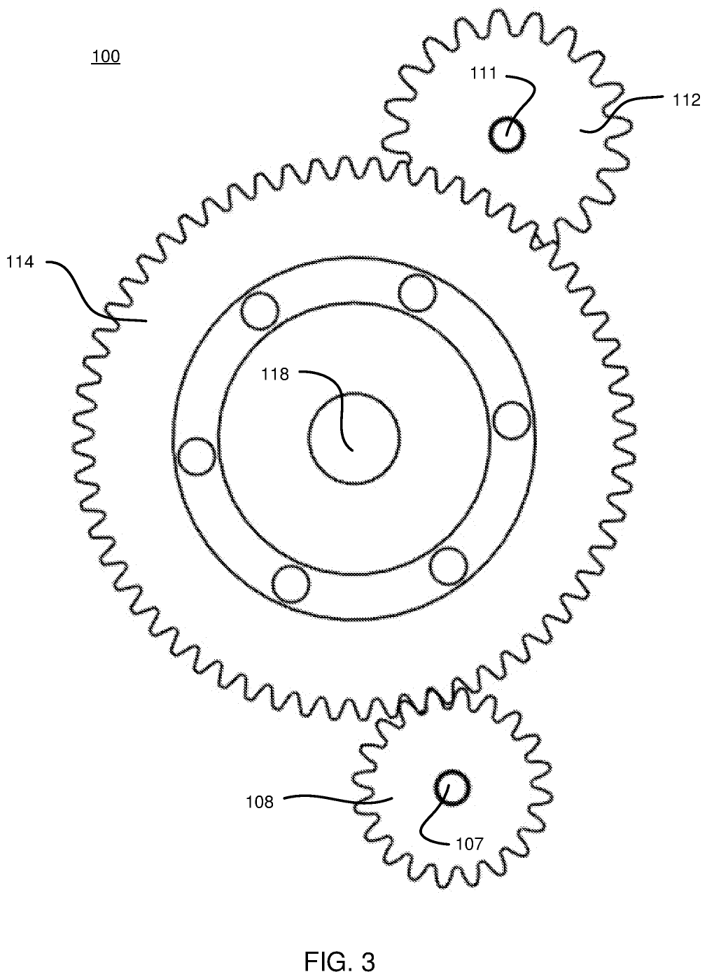

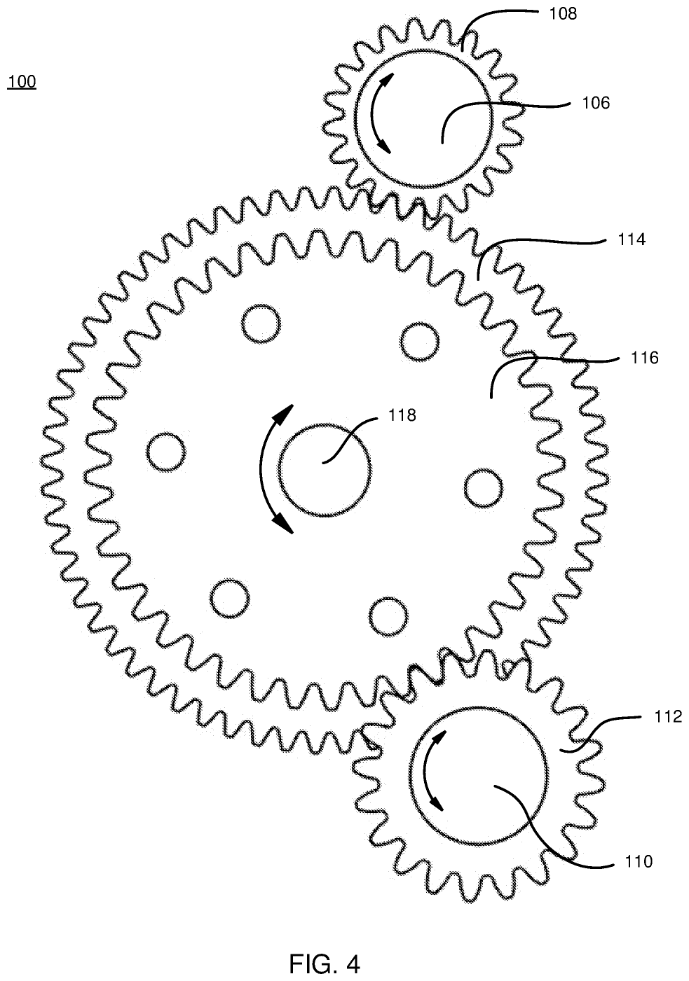

FIGS. 2-4 illustrate additional views of the system 100. FIG. 2 illustrates a straight-on side view of the system 100, FIG. 3 illustrates a top-down aerial view of the system 100, and FIG. 4 illustrates a view of an underside of the system.

FIG. 2 illustrates the axes of rotation for the pinion gears 108, 112 and bull gears 114, 116. The first pinion gear 108 affixed to the first shaft 107 rotates about a first axis of rotation 107. The second pinion gear 112 affixed to the second shaft 111 rotates about a second axis of rotation 111a. The bull gears 114, 116 affixed to the shaft 118 rotate about an axis of rotation 118a. The pinion gears 108, 112 and the bull gears 114, 116 may rotate in clockwise or counterclockwise directions.

The bull gears 114, 116 may each be affixed to the shaft 118 such that the bull gears 114, 116 rotate in the same direction at a given time. The pinion gears 108, 112 rotate in an opposite direction relative to the bull gears 114, 116. For example, if the shaft 118 and the bull gears 114, 116 are rotating in a clockwise direction, then each of the pinion gears 108, 112, and their respective shafts 107, 111 will rotate in a counterclockwise direction. Conversely, if the shaft 118 and the bull gears 114, 116 are rotating in a counterclockwise direction, then each of the pinion gears 108, 112, and their respective shafts 107, 111 will rotate in a clockwise direction

The system 100 is configured such that the pinion gears 108, 112 rotate in a direction opposite to the rotational direction of the bull gears 114, 116. However, the system 100 is not limited to this configuration. For example, an idler gear or other intermediate gear or device may be placed between and rotationally engaged with each bull gear 114, 116 and corresponding pinion gear 108, 112 to cause the bull gear 114, 116 and the pinion gears 108, 112 to rotate in the same direction. The disclosure may still be practiced in any configuration no matter which direction the gears turn with respect to each other.

In the top-down view illustrated in FIG. 3, the second bull gear 116 is not visible and only a portion of the second pinion gear 112 is visible. FIG. 3 illustrates the interaction between the first pinion gear 108 and the first bull gear 114.

In the underside view illustrated in FIG. 4, the second bull gear 116 and the second pinion gear 112 are more clearly shown. As seen in the figure, the first pinion gear 108 is connected to the first angular position sensor 106. The first pinion gear 108 and the first bull gear 114 rotationally engage with one another. The second pinion gear 112 and the second bull gear 116 rotationally engage with one another.

Each of the bull gears 114, 116 may be fixed to the shaft such that the bull gears 114, 116 rotate in the same direction at a given time. In most implementations, the pinion gears 108, 112 will rotate in a direction opposite to the direction of the bull gears 114, 116. For example, if the shaft 118 and the bull gears 114, 116 rotate in a clockwise direction, then the pinion gears 108, 112, their respective shafts 107, 117, and the angular position sensors 106, 110 will rotate in a counterclockwise direction. Likewise, if the shaft 118 and the bull gears 114, 116 rotate in a counterclockwise direction, then the pinion gears 108, 112, their respective shafts 107, 117, and the angular position sensors 106, 110 will rotate in a clockwise direction.

As shown in FIGS. 1-4, the system 100 may be configured such that the rotation direction of the pinion gears 108, 112 is opposite to the rotation direction of the bull gears 114, 116. However, the disclosure is not limited to this configuration. For example, an idler gear or other intermediate gear or device may be placed between and rotationally engaged with each bull gear 114, 116 and corresponding pinion gear 108, 112 to cause both the bull gears 114, 116 and the pinion gears 108, 112 to rotate in the same direction. The disclosure may still be practiced in any configuration no matter which way the gears turn with respect to each other.

The system 100 may be configured such that each of the gears are constructed with different sizes and/or different quantity of teeth. The bull gears 114, 116 and the pinion gears 108, 112 may each comprise a quantity of teeth equal to a non-zero integer.

FIGS. 1-4 illustrate, particularly FIG. 3, that each of the gears in the system 100 may be of different sizes and may have different numbers of teeth to each other. Each of the bull gears and pinion gears may have a number of teeth that is equal to non-zero integer. The bull gears 114, 116 and the pinion gears 108, 112 may have the same quantity of teeth or different quantities of teeth. Each gear may have a different quantity of teeth, or two or more gears may have a same quantity of teeth. In implementations wherein some gears have a different quantity of teeth and/or different sizes relative to the other gears, the gears may complete a full revolution at different times.

In the example illustrated in FIGS. 1-4, the first bull gear 114 and the second bull gear 116 are affixed to a same shaft 118 such that the first bull gear 114 and the second bull gear 116 complete a revolution at the same time. However, in the example shown, the first pinion gear 108 is smaller than the second pinion gear 112. Additionally, the second bull gear 116 is shown to be smaller than the first bull gear 114. According to the example shown, the first bull gear 114 has more teeth than the second bull gear 116 and the first and the second pinion gears 108, 112 each have equal numbers of teeth. However, the disclosure is not limited to this configuration, or the number of teeth shown on each gear in the figures. Each gear may have different number of teeth, or two or more gears may have the same number of teeth. Any number of teeth or size of gear for each of the bull gears and pinion gears may be chosen in order to meet set rules or specifications of a particular design.

The quantity of teeth chosen for each of the first pinion gear 108, the second pinion gear 112, the first bull gear 114, and the second bull gear 116 lead to different gear ratios for the gear sets including a first gear set including first pinion gear 108 and a first bull gear 114, and a second gear set including the second pinion gear 112 and the second bull gear 116. The gear ratio of each pair is defined as the number of teeth of the bull gear to the number of teeth of the pinion gear. The first gear ratio R₁ of the first gear set is defined as

$${R}_{1} = \frac{K}{M}$$

where K is the number of teeth on first bull gear 114 and M is the number of teeth on first pinion gear 108. The second gear ratio R₂ of the second gear set is defined as

$${R}_{2} = \frac{L}{N}$$

where L is the number of teeth on the second bull gear 116 and N is the number of teeth on the second pinion gear 112. Each gear ratio is also equal to the ratio of angular velocities and the ratio of pitch radii for the gears comprising the gear set.

To aid in determining angular position of the shaft 118, the bull gears 114, 116 and the pinion gears 108, 112 may be designed to fit the following specifications. The gear ratio R₁ of the first angular position sensor (e.g., first gear set) 106 minus the gear ratio R₂ of the second angular position sensor 110 (e.g., second gear set) equals 1, where the gear ratio R₁ of the first angular position sensor 106 is the ratio of the number of teeth on first bull gear 114 to the number of teeth on first pinion gear 108 and the gear ratio R₂ of the second angular position sensor 110 is the ratio of the number of teeth on the second bull gear 116 to the number of teeth on the second pinion gear 112.

The pitch of the first angular position sensor 106 is different than the pitch of the second angular position sensor 110. The pitch of each angular position sensor 106, 110 is defined as the pitch of the gears associated with the angular position sensor. For example, the first pinion gear 108 and the first bull gear 114 are the gears of the first angular position sensor 106. The second pinion gear 112 and the second bull gear 116 are the gears of second angular position sensor 110. As described above, the first pinion gear 108 and the first bull gear 114 are rotationally engaged with each other and the second pinion gear 112 and the second bull gear 116 are rotationally engaged with each other. In order for two gears that are rotationally engaged to mesh smoothly together, the engaged gears should each have the same pitch. The pitch of a gear is defined as follows:

$$P = \frac{2 π r}{N}$$

In the above equation, P is the pitch of the gear in question, r is the pitch radius of the gear, and N is the number of teeth on the gear. For each gear pair to mesh smoothly, the first pinion gear 108 should have a same pitch as the first bull gear 114. In equation form, the pitch of the first angular position sensor 106 should be as follows:

$${P}_{1} = \frac{2 π {r}_{K}}{K} = \frac{2 π {r}_{M}}{M}$$

Similarly, the second pinion gear 112 should have a same pitch as the second bull gear 116. In equation form, the pitch of the second angular position sensor 110 should be as follows:

$${P}_{2} = \frac{2 π {r}_{L}}{L} = \frac{2 π {r}_{N}}{N}$$

According to the design specifications outlined above, the radii and number of teeth of each gear should be chosen so that P₁ is not equal to P₂.

P₁≠P₂

The pinion gears and the bull gears are appropriately sized to fit the particular application of use for the angular positioning system/device.

The system 100 is designed such that the first gear ratio R₁ (of the gears of the first angular position sensor 106) minus the second gear ratio R₂ (of the gears of the second angular position sensor 110) is equal to 1. This ensures that both first gear ratio R₁ and the second gear ratio R₂ are different from each other. Because the bull gears 114, 116 are affixed to the same shaft 118, and therefore turn at the same rate, designing the system such that the first gear ratio R₁ is different from the second gear ratio R₂ results in a system where the first pinion gear 108 turns at a different rate than the second pinion gear 112. This introduces a difference or a “phase difference” between angular positions of the first angular position sensor 106 and the second angular position sensor 110 over time. In other words, a time at which the first pinion gear 108 completes a full revolution may be different from a time at which the second pinion gear 112 completes a full revolution. This similar effect is also achieved by causing the pitch of the gears of the first angular position sensor 106 to be different from the pitch of the gears of the second angular position sensor 110.

The controller 102 is configured to receive measurement data from the angular position sensors 106, 110. The sensor data indicates angular positions of the first angular position sensor 106 and the second angular position sensor 110. The controller 102 interprets the measurement data from the angular position sensors 106, 110 to determine the angular position of each angular position sensor 106, 110, and therefore, the angular positions of the first and the second pinion gears 108, 112. Having the measurement data from the first angular position sensor 106 and the second angular position sensor 110, the controller 102 calculates the angular position of the shaft 118 (as well as first bull gear 114 and the second bull gear 116) using the angular positions of the first angular position sensor 106 and the second angular position sensor 110. The controller 102 calculates the angular positions of the gears within the system 100 by running computer-executable instructions stored in a non-transitory computer-readable storage medium.

The controller 102 calculates the angular position of the shaft 118 in the following manner, based on the angular positions of the first and the second angular position sensors 106, 110. As described above, an angular position phase difference exists between rotation of the first pinion gear 108 and the second pinion gear 112. For example, each of the first pinion gear 108 and the second pinion gear 112 may start at an angular position of 0° at the immediate commencement of angular motion of the shaft 118. However, after an amount of time of rotation, one of the pinion gears may have turned through less angular rotation than the other. For example, after a rotation of shaft 118 by x degrees, the first pinion gear 108 may have moved by an angular rotation of y degrees while the second pinion gear 112 moves by an angular rotation of z degrees, depending on the differences of size, teeth, and gear ratios of the pinion gears. The difference in angular rotation rates of the pinion gears results in a phase difference between the angular positions of the pinion gears. The phase difference may be defined as a difference between the angular position of the first pinion gear 108 and the angular position of second pinion gear 112.

As rotation of the shaft 118 continues, the first pinion gear 108 and the second pinion gear 112 continue to turn at different rates and the phase difference may grow larger until eventually the pinion gears 108, 112 return to a same position at a same time. Proper design and calculation of the sizing, number of teeth, pitch, and other gear attributes for the system 100 may result in a phase difference where both the first pinion gear 108 and the second pinion gear 112 return to the 0° position at the same time after a plurality of rotations for both the first pinion gear 108 and the second pinion gear 112.

The number of teeth for each of the pinion gears 108, 112 and the bull gears 114, 116 may be selected such that a first gear ratio between the first pinion gear 108 and the first bull gear 114 is different than a second gear ratio between the second pinion gear 112 and the second bull gear 116. Each gear of the bull gears 114, 116 and the pinion gears 108, 112 may complete a full revolution at different times, depending on the gear ratio between rotationally engaged gears. In a case in which the first bull gear 114 and the second bull gear 116 are fixed to a same output shaft 118, the first bull gear 114 and the second bull gear 116 may complete a revolution at the same time and the pinion gears 108, 112 may complete revolutions at different times due to the difference in gear ratios between the first gear ratio of the first pinion gear 108 and the first bull gear 114, and the second gear ratio of the second pinion gear 112 and the second bull gear 116.

The controller 102 calculates a difference between a position of the first angular position sensor 106 and a position of the second angular position sensor 110 to calculate the angular position of the output shaft 118 based on a difference between the positions of the first angular position sensor 106 and the second angular position sensor 110. The difference between the angular position of the first angular position sensor 106 (first pinion gear 108) and the angular position of the second angular position sensor 110 (second pinion gear 112) may be referred to as a phase difference.

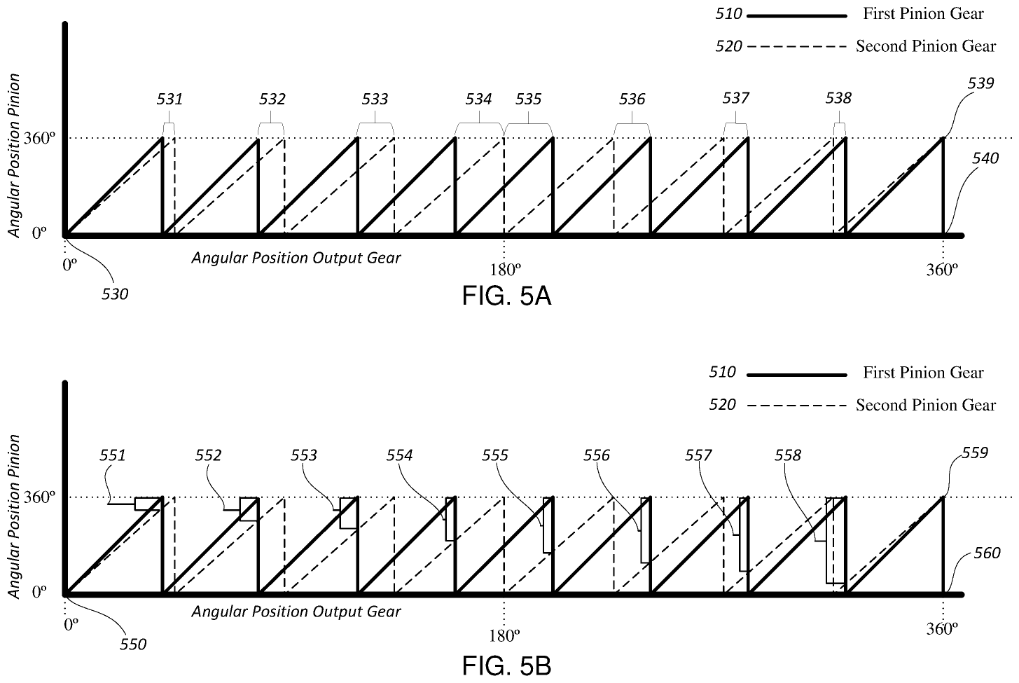

FIGS. 5A-5B each illustrate graphical representations of the difference between rotation rates and complete rotations, as well as a phase difference between first and the second pinion gears. FIG. 5A illustrates the different rotations rates of an exemplary first pinion gear (shown in FIG. 5A as line 510) and an exemplary second pinion gear (shown in FIG. 5A as line 520). The lines on the graphs shown in FIGS. 5A and 5B are merely exemplary and for illustrative purposes. The lines on the graphs may or may not coincide with an embodiment of the disclosure.

The graphs of FIGS. 5A and 5B show how different pinion gears with different gear ratios in a system may rotate at different rates, move out of phase, and eventually move back to a same angular position at a same time. Different angular positioning devices may be used according to the embodiments described herein and/or that meet the design specifications outlined above (i.e., gear ratio R₁ minus the gear ratio R₂ equals 1, the pitch of the first angular position sensor is different than the pitch of the second angular position sensor, the numbers of teeth on the pinion gears and the bull gears are all integer numbers, and the pinion and bull gears are appropriately sized to fit the particular application of use for the positioning system).

In the illustrated example of FIG. 5A, the first pinion gear 510 and the second pinion gear 520 both start rotation at an angular position of 0° at point 530. As rotation begins, the first pinion gear 510 and the second pinion gear 520 rotate at different rates such that, as an example, the first pinion gear 510 completes nine complete rotations for each single rotation of a shaft (e.g., the shaft 118 attached to the bull gears 114, 116). The second pinion gear 520 completes eight complete rotations for each single rotation of a shaft and each nine rotations for the first pinion gear 510. The difference in rotation rates between the pinion gears 510 and 520 causes the angular positions of the pinion gears to be out of sync with each other. As shown, a distance 531 between a peak of the first pinion gear 510 (i.e., a point where the pinion gear completes a rotation) and a nearest neighboring peak of the second pinion gear 520 that is nearest to the peak of the first pinion gear grows (e.g., distances 531, 532, 533, and 534 progressively expand) as rotation of the shaft and pinion gears continues. At a certain point, for example when the shaft is at 180°, a distance 534 between a peak of the first pinion gear 510 and a peak of the second pinion gear 520 may be equal to a distance 535 of the peak of second pinion gear 520 and an immediately following peak of the first pinion gear 510. This is merely an illustrative example: Depending on gear ratios, number of teeth, and sizes of gears in the system, a peak one pinion gear may or may not ever be equidistant between two peaks of another pinion gear.

Following a point in which distances 534 and 535 are equal to each other, the angular positions of the first pinion gear 510 and the second pinion gear 520 move closer to syncing up. In other words, distances 535-538 grow progressively smaller until the first pinion gear 510 and the second pinion gear 520 eventually complete a rotation at a same time signified by point 539 at 360° and point 540 at 0°, which points both coincide with an origin position of the first pinion gear 510 and the second pinion gear 520. Accordingly, an angular positioning system and device, when designed to meet certain specifications, may cause two pinion gears to start at a same origin, rotate at different rates, and return to a same origin at a desired point in time.

As shown, the pinion gears engaged with respective bull gears may return to an origin position at the same time corresponding to an origin position of the shaft being rotated. The pinion gears and bull gears according to the embodiments described herein may be designed such that pinion gears arrive at a common/shared angular position at any angular position of the shaft. Furthermore, pinion gears may be designed to complete any number of rotations during a single turn of the shaft.

FIG. 5B illustrates the relationship of phase difference between first and second pinion gears 510 and 520 to the angular position of a shaft attached to first and second bull gears. The “phase difference” is defined as a difference between an angular position of first pinion gear (e.g., 510) and a second pinion gear (e.g., 520) at a given point in time. Exemplary phase differences (551-558) are indicated in FIG. 5B at each peak of first pinion gear 510. As shown in FIG. 5B, the first pinion gear 510 and second pinion gear 520 begin at the same angular position of 0° at starting point 550. At each peak of first pinion gear 510, a phase difference is identified showing a difference between angular positions of first pinion gear 510 and second pinion gear 520 at the associated point. Although exemplary phase differences are illustrated at each peak, a phase difference between angular positions of first pinion gear 510 and second pinion gear 520 may be obtained at any and every point in time.

As shown, the phase difference between first pinion gear 510 and second pinion gear 520 increasingly grows as rotation of the shaft continues. Each progressive phase difference (551, 552, 553, 554, 555, 556, 557, and 558) is larger than those before it. The phase difference continually grows until points 559 and 556 at which time both the pinion gears and the shaft return to an angular position of 0°. Because the phase difference between pinion gears is continually growing as the angular position of the shaft is rotated from 0° to 360°, the phase difference between pinion gears at any given point in time may be associated with a unique angular position of the shaft. In other words, knowing the current phase difference between pinion gears at any point in time allows controller 102 to determine the angular position of the shaft, which is uniquely associated with the phase difference of the pinion gears. Accordingly, by knowing the phase difference of the pinion gears, controller 102 may uniquely and accurately define the current angular position of the shaft based on known relationships between the angular position of the output gear/shaft 118 and the phase difference between angular positions of the first and second pinion gears.

An alternative embodiment and method of calculation will now be described. Under perfect, theoretical conditions, the phase difference between pinion gears may completely accurately define the position of the output gear. However, in real world conditions, some error and/or noise may be present in one or more angular position sensors, which may lead to a certain amount of inaccuracy in determining the angular position of the output gear. For example, an angular position sensor such as those described herein may have a margin of error of approximately ±n-arc minutes. As such, a phase difference between first and second pinion gears determined by the controller 102 may not be precisely accurate. Accordingly, in alternative embodiments, controller 102 may perform alternative or additional calculations and determinations to more accurately determine angular positions of pinion gears, and therefore, the output gear.

Controller 102 may obtain a fine measurement and a coarse measurement to define a position of an output gear/shaft more accurately. The fine measurement and the course measurement may be combined to calculate a more accurate angular position of the output. In this example, the phase difference between angular positions of the pinion gears can be used as an intermediate calculation instead of a final determination of angular position. The phase difference may be used as a coarse measurement of the output angular position. The coarse measurement may identify a general range in which the true output gear angular position is included.

The coarse measurement may be determined in a variety of ways by using a variety of different possible calculations. For example, the coarse measurement may be determined by simply taking the phase difference between the angular position of the pinion gears as the coarse measurement. Alternatively, the coarse measurement may be the phase difference rounded to the nearest degree, two degrees, three degrees, etc. In other words, the coarse measurement may be the phase difference rounded up or down a predetermined number n of degrees. The pinion phase difference can also be rounded to a center, upper end, or lower end of a predefined range.

The fine measurement may be determined in the following manner. Because of different relative gear ratios between a first gear set and a second gear set, a relatively small rotation of the bull gears 114, 116 may produce a relatively large rotation of one or more of the pinion gears 108, 112. Although either of the first pinion gear or the second pinion gear may be used to determine the fine measurement, this example will specifically refer to the first pinion gear 108. The first pinion gear 108, for example, rotates a plurality of full rotations within the same amount of time that the first bull gear 114 of the output gear rotates through a single full rotation. In other words, when the first pinion gear 108 completes a full 360° rotation, the output gear (e.g., first bull gear 114 fixed to shaft 118) rotates only a partial rotation. The partial rotation of the output gear (first bull gear 114) is equal to 360° divided by the gear ratio between the first pinion gear 108 and the first bull gear 114. As described above the first gear ratio for the first pinion gear 108 and the first bull gear 114 may be

$${R}_{1} = \frac{K}{M} ,$$

where K is the number of teeth on first bull gear 114 and M is the number of teeth on first pinion gear 108. The second gear ratio for the second pinion gear 112 and the second bull gear 116 may be

$${R}_{2} = \frac{L}{N} ,$$

where L is the number of teeth on the second bull gear 116 and N is the number of teeth on the second pinion gear 112.

One of the pinion gears 108, 112 may be selected to determine the fine measurement. Either of the pinion gears 108, 112 may be selected as the gear for determining the fine measurement. For example, if the first pinion gear 108 is selected for use in determining the fine measurement, the fine measurement may be determined for the first pinion gear 108 by obtaining the angular position of the first pinion gear 108 from the first angular position sensor 106 and dividing the angular position of the first pinion gear 108 by the first gear ratio

$$( e . g . , \frac{K}{M}$$

for the first gear set) between the first bull gear 114 and the first pinion gear 108. Dividing the angular position of the first pinion gear 108 by the first gear ratio also divides error and noise inherent in the first angular position sensor 106 by the same ratio. Because the error is divided by the gear ratio in the determination of the fine measurement, the error and noise are reduced. By this calculation error is reduced and the angular position of the first pinion gear 108 may be used to calculate the fine measurement to be more accurate. Although this example showed how to determine fine and coarse measurements using the first pinion gear 108 and the first bull gear 114, the same operation may be done using the second pinion gear 112 and the second bull gear 116.

Once both the fine and coarse measurements are determined according to the disclosure above, the coarse measurement and the fine measurement may be added together. The result of the addition is the angular position of the output gear (e.g., first and second bull gears 114, 116 fixed to shaft 118). Using these or similar processes, error and noise within the angular position sensors 106, 110 may be reduced and/or substantially eliminated from the resulting output gear angular position 304 and may lead to a more accurate calculation of the angular position of the output gear.

Data and measurements collected of angular positions of the first and second pinion gears 108, 112 based on data from first angular position sensor 106 and second angular position sensor 110 can be analyzed by one or more software programs to calculate the angular position of shaft 118. As shown in FIG. 1, angular positioning system 100 may include controller 102 for analyzing measurements and data from first angular position sensor 106 and second angular position sensor 110 to calculate the angular position of shaft 118.

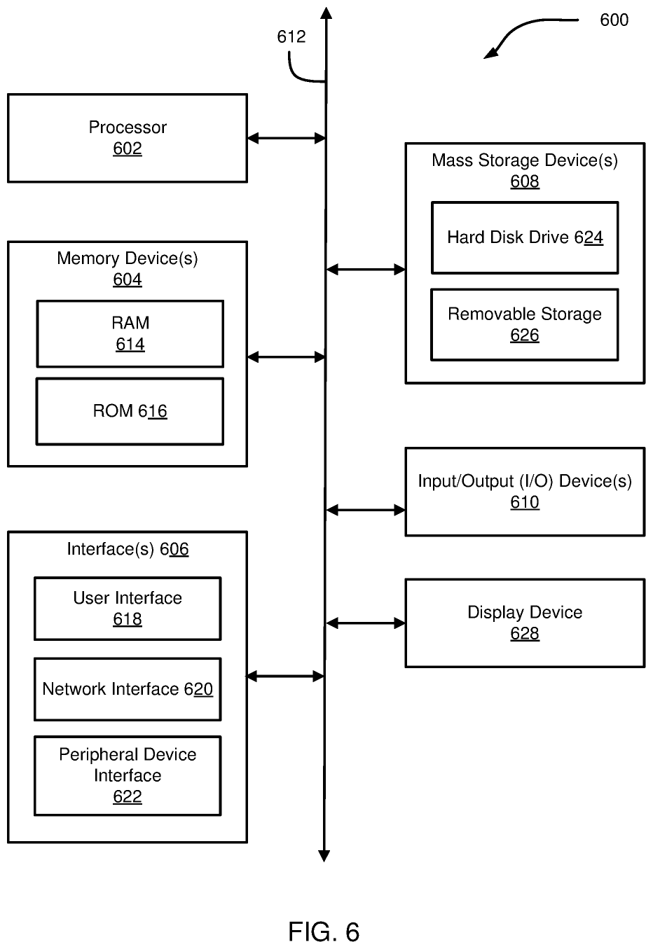

Alternatively, angular positioning system 100 may send data via internet, wired, or wireless connections to an outside computing device for data analysis and storage. An angular positioning system 100 may include angular positioning device 102 and an outside computing system/controller (e.g., controller 102) to analyze the data and measurements from angular positioning device 102. Whether the data analysis and calculations are carried out in a controller in angular positioning system 100 or an outside computer, either may include one or more of the components described below and shown in FIG. 6.

FIG. 6 is a schematic diagram of complementary system hardware such as a special purpose or general-purpose computer. Either a controller of angular positioning system 100 or an outside computer may perform the function of a special purpose or general-purpose computer. Implementations within the scope of the present disclosure may also include physical and other non-transitory computer readable media for carrying or storing computer executable instructions and/or data structures. Such computer readable media can be any available media that can be accessed by a general purpose or special purpose computer system. Computer readable media that stores computer executable instructions are computer storage media (devices). Computer readable media that carry computer executable instructions are transmission media. Thus, by way of example, and not limitation, implementations of the disclosure can comprise at least two distinctly different kinds of computer readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer executable instructions or data structures and which can be accessed by a general purpose or special purpose computer.

A “network” is defined as one or more data links that enable the transport of electronic data between computer systems and/or modules and/or other electronic devices. In an implementation, a sensor and camera controller may be networked to communicate with each other, and other components, connected over the network to which they are connected. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer executable instructions or data structures and which can be accessed by a general purpose or special purpose computer. Combinations of the above should also be included within the scope of computer readable media.

Further, upon reaching various computer system components, program code means in the form of computer executable instructions or data structures that can be transferred automatically from transmission media to computer storage media (devices) (or vice versa). For example, computer executable instructions or data structures received over a network or data link can be buffered in RAM within a network interface module (e.g., a “NIC”), and then eventually transferred to computer system RAM and/or to less volatile computer storage media (devices) at a computer system. RAM can also include solid state drives (SSDs or PCIx based real time memory tiered storage, such as FusionIO). Thus, it should be understood that computer storage media (devices) can be included in computer system components that also (or even primarily) utilize transmission media.

Computer executable instructions comprise, for example, instructions and data which, when executed by one or more processors, cause a general-purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, controllers, camera controllers, hand-held devices, hand pieces, multi-processor systems, microprocessor-based or programmable consumer electronics, network PCs, minicomputers, mainframe computers, mobile telephones, PDAs, tablets, pagers, routers, switches, various storage devices, and the like. It should be noted that any of the above-mentioned computing devices may be provided by or located within a brick-and-mortar location. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) or field programmable gate arrays (FPGAs) can be programmed to carry out one or more of the systems and procedures described herein. Certain terms are used throughout the following description and claims to refer to particular system components. As one skilled in the art will appreciate, components may be referred to by different names. This document does not intend to distinguish between components that differ in name, but not function.

FIG. 6 is a block diagram illustrating an example computing device 600. Computing device 600 may be used to perform various procedures, such as those discussed herein. Computing device 600 can function as a server, a client, or any other computing entity. Computing device 600 can perform various monitoring functions as discussed herein, and can execute one or more application programs, such as the application programs described herein. Computing device 600 can be any of a wide variety of computing devices, such as a desktop computer, a notebook computer, a server computer, a handheld computer, camera controller, tablet computer and the like.

Computing device 600 includes one or more processor(s) 602, one or more memory device(s) 604, one or more interface(s) 606, one or more mass storage device(s) 608, one or more Input/Output (I/O) device(s) 610, and a display device 628 all of which are coupled to a bus 612. Processor(s) 602 include one or more processors or controllers that execute instructions stored in memory device(s) 604 and/or mass storage device(s) 608. Processor(s) 602 may also include various types of computer readable media, such as cache memory.

Memory device(s) 604 include various computer readable media, such as volatile memory (e.g., random access memory (RAM) 614) and/or nonvolatile memory (e.g., read-only memory (ROM) 616). Memory device(s) 604 may also include rewritable ROM, such as Flash memory.

Mass storage device(s) 608 include various computer readable media, such as magnetic tapes, magnetic disks, optical disks, solid-state memory (e.g., Flash memory), and so forth. As shown in FIG. 6, a particular mass storage device is a hard disk drive 624. Various drives may also be included in mass storage device(s) 608 to enable reading from and/or writing to the various computer readable media. Mass storage device(s) 608 include removable media 626 and/or non-removable media.

I/O device(s) 610 include various devices that allow data and/or other information to be input to or retrieved from computing device 600. Example I/O device(s) 610 include digital imaging devices, electromagnetic sensors and emitters, cursor control devices, keyboards, keypads, microphones, monitors or other display devices, speakers, printers, network interface cards, modems, lenses, CCDs or other image capture devices, and the like.

Display device 628 includes any type of device capable of displaying information to one or more users of computing device 600. Examples of display device 628 include a monitor, display terminal, video projection device, and the like.

Interface(s) 606 include various interfaces that allow computing device 600 to interact with other systems, devices, or computing environments. Example interface(s) 606 may include any number of different network interfaces 620, such as interfaces to local area networks (LANs), wide area networks (WANs), wireless networks, and the Internet. Other interface(s) include user interface 618 and peripheral device interface 622. The interface(s) 606 may also include one or more user interface elements 618. The interface(s) 606 may also include one or more peripheral interfaces such as interfaces for printers, pointing devices (mice, track pad, etc.), keyboards, and the like.

Bus 612 allows processor(s) 602, memory device(s) 604, interface(s) 606, mass storage device(s) 608, and I/O device(s) 610 to communicate with one another, as well as other devices or components coupled to bus 612. Bus 612 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 600 and are executed by processor(s) 602. Alternatively, the systems and procedures described herein can be implemented in hardware, or a combination of hardware, software, and/or firmware. For example, one or more application specific integrated circuits (ASICs) or field programmable gate arrays (FPGAs) can be programmed to carry out one or more of the systems and procedures described herein.

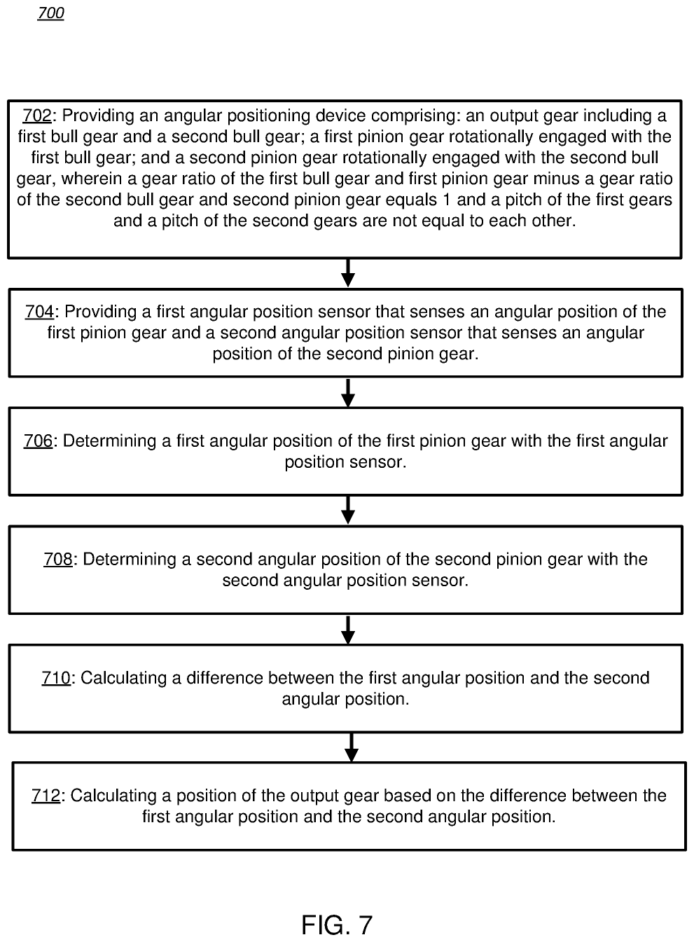

FIG. 7 illustrates an exemplary method according to at least one embodiment of the present disclosure. The method 700 includes the following steps. Step 702 of method 700 includes providing an angular positioning device comprising: an output gear including a first bull gear and a second bull gear; a first pinion gear rotationally engaged with the first bull gear; and a second pinion gear rotationally engaged with the second bull gear. As described above in this disclosure, the first and second pinion gears and first and second bull gears may be designed, sized, and formed such that a gear ratio of the first bull gear to the first pinion gear minus a gear ratio of the second bull gear to the second pinion gear equals 1. The gears may further be sized such that a pitch of the first gears (first pinion gear and first bull gear) and a pitch of the second gears (second pinion gear and second bull gear) are not equal to each other. A number of teeth for each gear may be a non-zero integer number of teeth. Additionally, the sizes of the gears may be chosen to fit the particular application the angular positioning device is being used for.

Step 704 of method 700 may include providing a first angular position sensor that senses an angular position of the first pinion gear and a second angular position sensor that senses an angular position of the second pinion gear. The method may further comprise providing a controller that receives the first and second angular positions from the first and second angular position sensors.

Step 706 may include determining a first angular position of the first pinion gear with the first angular position sensor. Step 708 of method 700 may include determining a second angular position of the second pinion gear with the second angular position sensor. Step 710 of method 700 may include calculating (e.g., by a controller) a difference between the first angular position and the second angular position. Step 712 of method 700 may include calculating a position of the output gear based on the difference between the first angular position and the second angular position.

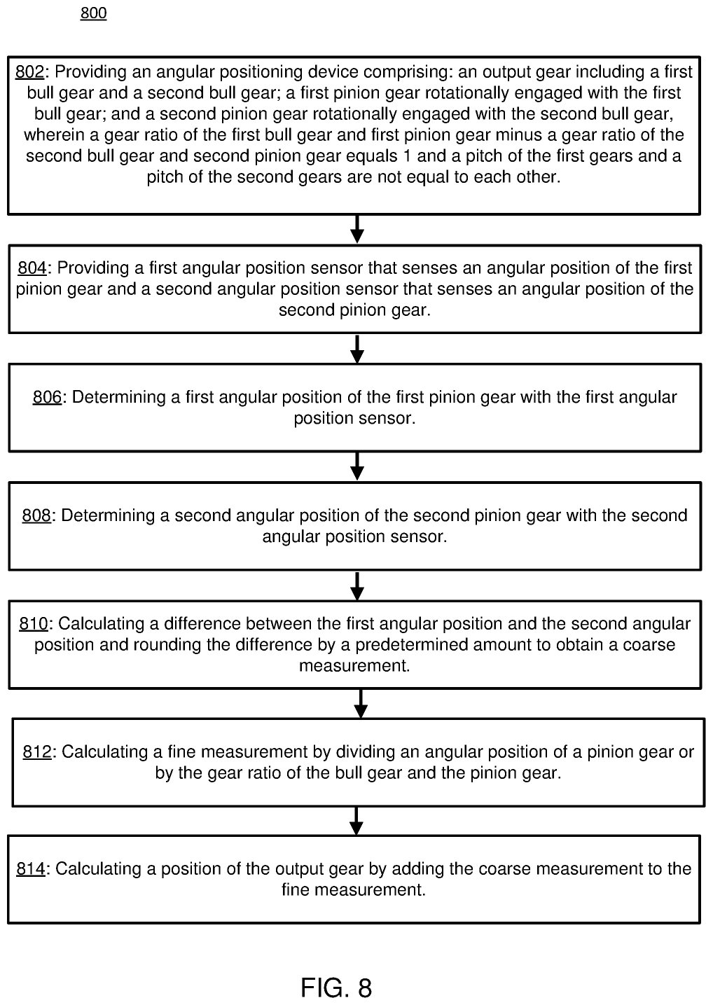

FIG. 8 illustrates an exemplary method according to at least one embodiment of the present disclosure wherein fine and coarse measurements are calculated to determine. The method 800 includes the following steps. Step 802 of method 800 includes providing an angular positioning device comprising: an output gear including a first bull gear and a second bull gear; a first pinion gear rotationally engaged with the first bull gear; and a second pinion gear rotationally engaged with the second bull gear. As described above in this disclosure, the first and second pinion gears and first and second bull gears may be designed, sized, and formed such that a gear ratio of the first bull gear to the first pinion gear minus a gear ratio of the second bull gear to the second pinion gear equals 1. The gears may further be sized such that a pitch of the first gears (first pinion gear and first bull gear) and a pitch of the second gears (second pinion gear and second bull gear) are not equal to each other. A number of teeth for each gear may be a non-zero integer number of teeth. Additionally, the sizes of the gears may be chosen to fit the particular application the angular positioning device is being used for.

Step 804 of method 800 may include providing a first angular position sensor that senses an angular position of the first pinion gear and a second angular position sensor that senses an angular position of the second pinion gear. The method may further comprise providing a controller that receives the first and second angular positions from the first and second angular position sensors.

Step 806 may include determining a first angular position of the first pinion gear with the first angular position sensor. Step 808 of method 800 may include determining a second angular position of the second pinion gear with the second angular position sensor. Step 810 of method 800 may include calculating (e.g., by a controller) a difference between the first angular position and the second angular position and rounding the difference by a predetermined amount to obtain a coarse measurement. The predetermined amount may comprise rounding the difference to a nearest degree, two degrees, three degrees, or any other desired proportion or amount. Step 812 of method 800 may include calculating a fine measurement by dividing an angular position of a pinion gear or by the gear ratio of the bull gear and the pinion gear. Step 814 of method 800 may include calculating a position of the output gear by adding the coarse measurement to the fine measurement.

### EXAMPLES

The following examples pertain to further embodiments of the disclosure.

Example 1 is a system. The system includes a first bull gear and a second bull gear rigidly connected to the first bull gear. The system includes a first pinion gear rotationally engaged with the first bull gear. The system includes a second pinion gear rotationally engaged with the second bull gear. The system includes a first sensor that senses a first angular position of the first pinion gear. The system includes a second sensor that senses a second angular position of the second pinion gear.

Example 2 is a system as in Example 1, wherein the first bull gear comprises a first plurality of teeth with a first pitch, wherein the second bull gear comprises a second plurality of teeth with a second pitch, and wherein the first pitch is different from the second pitch.

Example 3 is a system as in any of Examples 1-2, wherein the first bull gear comprises a first plurality of teeth with a first pitch, wherein the second bull gear comprises a second plurality of teeth with a second pitch, and wherein the first pitch is equivalent to the second pitch.

Example 4 is a system as in any of Examples 1-3, wherein: the first bull gear and the first pinion gear constitute a first gear set comprising a first gear ratio defined by a ratio between a quantity of teeth of the first bull gear and a quantity of teeth of the first pinion gear; and the second bull gear and the second pinion gear constitute a second gear set comprising a second gear ratio defined by a ratio between a quantity of teeth of the second bull gear and a quantity of teeth of the second pinion gear.

Example 5 is a system as in any of Examples 1-4, wherein a difference between the first gear ratio and the second gear ratio is equal to one.

Example 6 is a system as in any of Examples 1-5, wherein a difference between the first gear ratio and the second gear ratio is equal to two.

Example 7 is a system as in any of Examples 1-6, wherein a difference between the first gear ratio and the second gear ratio is equal to three.

Example 8 is a system as in any of Examples 1-7, wherein a difference between the first gear ratio and the second gear ratio is equal to 0.5.

Example 9 is a system as in any of Examples 1-8, further comprising a shaft disposed through each of the first bull gear and the second bull gear, wherein the shaft rigidly connects the first bull gear and the second bull gear.

Example 10 is a system as in any of Examples 1-9, wherein the first pinion gear comprises a pitch that is equivalent to a pitch of the second pinion gear.

Example 11 is a system as in any of Examples 1-10, wherein the first bull gear comprises a first diameter, wherein the second bull gear comprises a second diameter, and wherein the first diameter is different from the second diameter.

Example 12 is a system as in any of Examples 1-11, wherein the first bull gear comprises a first diameter, wherein the second bull gear comprises a second diameter, and wherein the first diameter is equivalent to the second diameter.

Example 13 is a system as in any of Examples 1-12, further comprising a controller that receives sensor data from the first sensor and the second sensor, wherein the controller is configured to calculate a difference between the first angular position and the second angular position.

Example 14 is a system as in any of Examples 1-13, further comprising a shaft that rigidly connects the first bull gear to the second bull gear, wherein the controller is further configured to calculate an angular position of the shaft based on the difference between the first angular position and the second angular position.

Example 15 is a system as in any of Examples 1-14, wherein one or more of: the first bull gear comprises a pitch that is equivalent to a pitch of the first pinion gear; or the second bull gear comprises a pitch that is equivalent to a pitch of the second pinion gear.

Example 16 is a system as in any of Examples 1-15, wherein the first bull gear and the second bull gear constitute independent gears that are each rigidly affixed to a shaft, and wherein the shaft is disposed through each of the first bull gear and the second bull gear.

Example 17 is a system as in any of Examples 1-16, further comprising a controller that calculates an angular position of the shaft in real-time based on the first angular position of the first pinion gear and the second angular position of the second pinion gear.

Example 18 is a system as in any of Examples 1-17, wherein the system is disposed within an antenna system for determining a real-time angular position of an antenna element.

Example 19 is a system as in any of Examples 1-18, further comprising a controller in electrical communication with each of the first sensor and the second sensor, wherein the controller is configured to execute instructions stored in non-transitory computer readable storage medium, the instructions comprising: calculating a difference between the first angular position and the second angular position; and determining an absolute position of each of the first bull gear and the second bull gear based at least in part on the difference between the first angular position and the second angular position.

Example 20 is a system as in any of Examples 1-19, wherein the first pinion gear and the second pinion gear are configured to rotate at different rates.

Example 21 is a system as in any of Examples 1-20, wherein the first pinion gear and the second pinion gear are configured to begin rotating at a defined origin position, rotate at different rates, and then return to the defined origin position at a desired point in time.

Example 22 is a system as in any of Examples 1-21, further comprising a shaft disposed through and rigidly affixed to each of the first bull gear and the second bull gear, wherein the defined origin position is defined as an origin of the shaft such that the first pinion gear and the second pinion gear return to the defined origin position after the shaft makes one complete rotation.

Example 23 is a system as in any of Examples 1-22, further comprising a controller that calculates an angular position of the shaft in real-time based on the first angular position and the second angular position.

The foregoing description has been presented for purposes of illustration. It is not exhaustive and does not limit the invention to the precise forms or embodiments disclosed. Modifications and adaptations will be apparent to those skilled in the art from consideration of the specification and practice of the disclosed embodiments. For example, components described herein may be removed and other components added without departing from the scope or spirit of the embodiments disclosed herein or the appended claims, if any.

Other embodiments will be apparent to those skilled in the art from consideration of the specification and practice of the disclosure disclosed herein. It is intended that the specification and examples be considered as exemplary only, with a true scope and spirit of the invention being indicated by the following claims, if any.

What is claimed is:

1. A system for determining absolute position, the system comprising:
a first bull gear;
a second bull gear rigidly connected to the first bull gear;
a first pinion gear rotationally engaged with the first bull gear;
a second pinion gear rotationally engaged with the second bull gear;
a first sensor that senses a first angular position of the first pinion gear; and
a second sensor that senses a second angular position of the second pinion gear.

2. The system of claim 1, wherein the first bull gear comprises a first plurality of teeth with a first pitch, wherein the second bull gear comprises a second plurality of teeth with a second pitch, and wherein the first pitch is different from the second pitch.

3. The system of claim 1, wherein the first bull gear comprises a first plurality of teeth with a first pitch, wherein the second bull gear comprises a second plurality of teeth with a second pitch, and wherein the first pitch is equivalent to the second pitch.

4. The system of claim 1, wherein:
the first bull gear and the first pinion gear constitute a first gear set comprising a first gear ratio defined by a ratio between a quantity of teeth of the first bull gear and a quantity of teeth of the first pinion gear; and
the second bull gear and the second pinion gear constitute a second gear set comprising a second gear ratio defined by a ratio between a quantity of teeth of the second bull gear and a quantity of teeth of the second pinion gear.

5. The system of claim 4, wherein a difference between the first gear ratio and the second gear ratio is equal to one.

6. The system of claim 1, further comprising a shaft disposed through each of the first bull gear and the second bull gear, wherein the shaft is rigidly connected to the first bull gear and the second bull gear.

7. The system of claim 1, wherein the first pinion gear comprises a pitch that is equivalent to a pitch of the second pinion gear.

8. The system of claim 1, wherein the first bull gear comprises a first diameter, wherein the second bull gear comprises a second diameter, and wherein the first diameter is different from the second diameter.

9. The system of claim 1, wherein the first bull gear comprises a first diameter, wherein the second bull gear comprises a second diameter, and wherein the first diameter is equivalent to the second diameter.

10. The system of claim 1, further comprising a controller that receives sensor data from the first sensor and the second sensor, wherein the controller is configured to calculate a difference between the first angular position and the second angular position.

11. The system of claim 10, further comprising a shaft that rigidly connects the first bull gear to the second bull gear, wherein the controller is further configured to calculate an angular position of the shaft based on the difference between the first angular position and the second angular position.

12. The system of claim 1, wherein one or more of:
the first bull gear comprises a pitch that is equivalent to a pitch of the first pinion gear; or
the second bull gear comprises a pitch that is equivalent to a pitch of the second pinion gear.

13. The system of claim 1, wherein the first bull gear and the second bull gear constitute independent gears that are each rigidly affixed to a shaft, and wherein the shaft is disposed through each of the first bull gear and the second bull gear.

14. The system of claim 13, further comprising a controller that calculates an angular position of the shaft in real-time based on the first angular position of the first pinion gear and the second angular position of the second pinion gear.

15. The system of claim 1, wherein the system is disposed within an antenna system for determining a real-time angular position of an antenna element.

16. The system of claim 1, further comprising a controller in electrical communication with each of the first sensor and the second sensor, wherein the controller is configured to execute instructions stored in non-transitory computer readable storage medium, the instructions comprising:
calculating a difference between the first angular position and the second angular position; and
determining an absolute position of each of the first bull gear and the second bull gear based at least in part on the difference between the first angular position and the second angular position.

17. The system of claim 1, wherein the first pinion gear and the second pinion gear are configured to rotate at different rates.

18. The system of claim 17, wherein the first pinion gear and the second pinion gear are configured to begin rotating at a defined origin position, rotate at different rates, and then return to the defined origin position at a desired point in time.

19. The system of claim 18, further comprising a shaft disposed through and rigidly affixed to each of the first bull gear and the second bull gear, wherein the defined origin position is defined as an origin of the shaft such that the first pinion gear and the second pinion gear return to the defined origin position after the shaft makes one complete rotation.

20. The system of claim 19, further comprising a controller that calculates an angular position of the shaft in real-time based on the first angular position and the second angular position.
